(19) United States
(12) Patent Application Publication
(10) Pub. No.: US 2013/0059162 A1
(43) Pub. Date: Mar. 7, 2013

(54) FLUX COMPOSITION AND BRAZING SHEET

(71) Applicants: Nobuhiro KOBAYASHI, Kobe-shi (JP); Motohiro Horiguchi, Kobe-shi (JP); Kazutaka Kunii, Kobe-shi (JP); Toshiki Ueda, Moka-shi (JP); Shimpei Kimura, Moka-shi (JP)

(72) Inventors: Nobuhiro KOBAYASHI, Kobe-shi (JP); Motohiro Horiguchi, Kobe-shi (JP); Kazutaka Kunii, Kobe-shi (JP); Toshiki Ueda, Moka-shi (JP); Shimpei Kimura, Moka-shi (JP)

(73) Assignee: Kabushiki Kaisha Kobe Seiko Sho (Kobe Steel, Ltd.), Kobe-shi (JP)

(21) Appl. No.: 13/593,830

(22) Filed: Aug. 24, 2012

(30) Foreign Application Priority Data
Aug. 24, 2011 (JP) 2011-183063

(51) Int. Cl. B23K 35/363; B32B 15/04

(52) U.S. Cl. 428/457; 148/26

(57) ABSTRACT

Disclosed are: a flux composition which is used for brazing of a magnesium-containing aluminum alloy material, suppresses the formation of high-melting compounds, provides better wettability, and thereby exhibits better brazability even applied in a small mass of coating; and a brazing sheet using the flux composition. The flux composition for brazing of a magnesium-containing aluminum alloy material includes a flux component [A] containing fluorides as principal components; and an additive [B] being at least one selected from the group consisting of CeF₃, BaF₂, and ZnSO₄. The flux component [A] preferably contains KF in a content of 40 percent by mass or more and 60 percent by mass or less; and AlF₃ in a content of 40 percent by mass or more and 60 percent by mass or less.

### CROSS-REFERENCE TO RELATED APPLICATION

This application is based upon and claims the benefit of priority from prior Japanese Patent Application No. 2011-183063 filed on Aug. 24, 2011.

### FIELD OF THE INVENTION

The present invention relates to a flux composition for brazing of a magnesium-containing aluminum alloy material, and to a brazing sheet using the flux composition.

### BACKGROUND OF THE INVENTION

With a growing interest in environmental issues, weight reduction typically in the automotive industry has been proceeded for better fuel efficiency. Corresponding to the need for weight reduction, aluminum clad materials (brazing sheets) for automotive heat exchangers have been energetically examined so as to have smaller thickness and higher strength. Of the brazing sheets, those having a three-layer structure including a sacrificial material (e.g., an Al—Zn material), a core material (e.g., an Al—Si—Mn—Cu material), and a filler material (e.g., an Al—Si material) arranged in this order are generally employed. For higher strengths, addition of magnesium (Mg) to the core material has been investigated so as to provide higher strengths due to the precipitation of Mg₂Si.

Joining of such a brazing sheet upon assembly typically of a heat exchanger widely employs a flux brazing technique. The flux serves to improve brazability and is generally a mixture of AlF₃ and KF.

However, a brazing sheet including a core material composed of a magnesium-containing aluminum alloy, when employing the aforementioned flux, disadvantageously suffers from deterioration in brazability. This is probably because Mg in the core material migrates into the flux in the surface of the filler material upon heating for brazing, the migrated Mg reacts with the flux components to form high-melting compounds (e.g., KMgF₃ and MgF₂) to thereby consume the flux components, and this causes the flux to have insufficient wettability (spreadability upon brazing). For this reason, a demand has been made to develop a flux composition for a magnesium-containing aluminum alloy, so as to advance weight reduction typically in automotive heat exchangers.

Under these circumstances, investigations have been made on flux compositions which help brazing sheets including a magnesium-containing aluminum alloy core material to have better brazability, and there have been proposed flux compositions prepared by adding, to customary flux components, (1) CsF (see JP-A No. S61-162295); or (2) CaF₂, NaF, or LiF (see Japanese Unexamined Patent Application Publication (JP-A) No. S61-99569 and JP-A No. S57-68297).

However, the flux composition (1) added with CsF is not suitable typically for mass production and is not so practical, because cesium (Cs) is very expensive. In contrast, the patent documents mention that the flux compositions (2) typically with CaF₂ allow the flux to have a lower melting point to thereby have better wettability. However, despite that the wettability of a flux varies depending on the mass of coating thereof, the respective patent documents fail to consider the mass of coating of the flux. Accordingly, the flux compositions typically with CaF₂, when used, may require a larger mass of coating so as to exhibit sufficient wettability, thus causing increased cost.

### SUMMARY OF THE INVENTION

Under these circumstances, an object of the present invention is to provide a flux composition which is to be used for brazing of a magnesium-containing aluminum alloy material, and, upon the brazing, less forms high-melting compounds, provides better wettability even in a small mass of coating, and thereby gives better brazability. Another object of the present invention is to provide a brazing sheet using the flux composition.

The present invention achieves the objects and provides, in an aspect, a flux composition for brazing of a magnesium-containing aluminum alloy material. The flux composition includes:
a flux component [A] containing one or more fluorides as principal components; and
an additive [B] being at least one selected from the group consisting of CeF₃, BaF₂, and ZnSO₄.

The flux (composition) gives better wettability and thereby provides better brazability even applied in a small mass of coating (mass of deposit per unit area), because the additive [B] suppresses the formation of high-melting compounds.

In a preferred embodiment, the flux component [A] contains KF and AlF₃, and the flux component [A] contains KF in a content of 40 percent by mass or more and 60 percent by mass or less; and AlF₃ in a content of 40 percent by mass or more and 60 percent by mass or less, each based on the total mass of the flux component [A]. The flux component [A], when having the above-specified composition, helps the flux composition to have a lower melting point within a preferred range and to thereby have better wettability.

In another preferred embodiment, the additive [B] is contained in a content of 1 part by mass or more and 300 parts by mass or less per 100 parts by mass of the flux component [A]. The additive [B], when contained in a content within this range, may help the flux composition to give both better wettability and sufficient strength of the brazing region after bonding.

The present invention further provides, in another aspect, a brazing sheet including:
a core material including a magnesium-containing aluminum alloy;
a filler material being present on or above at least one side of the core material; and
a flux layer being present on or above a surface of the filler material and including the flux composition.

The brazing sheet further includes a flux layer composed of the flux composition on a surface of a filler material and, upon brazing, less causes the formation of high-melting compounds derived from magnesium in the core material. The brazing sheet can thereby provide better brazability.

In a preferred embodiment, the amount of the flux composition in the flux layer is 0.5 g/m² or more and 100 g/m² or less. The brazing sheet according to this embodiment can suppress the production cost while exhibiting satisfactory brazability, because the brazing sheet employs the flux composition in such a small amount within the above-specified range.

As is described above, the flux composition according to the present invention less causes the formation of high-melting compounds, helps the flux on a magnesium-containing aluminum alloy material to have better wettability and thereby to exhibit better brazability even applied in a small mass of coating. The brazing sheet according to the present invention employs the flux composition and thereby has satisfactory brazability. A structure brazed with the brazing sheet according to the present invention can have both a high strength and a light weight as a structure using a magnesium-containing aluminum alloy material and is usable typically as automotive heat exchangers.

### BRIEF DESCRIPTION OF THE DRAWINGS

FIG. 1 is a graph synthetically illustrating evaluation results in working examples;

FIG. 2 is a scanning electron photomicrograph (SEM) illustrating how a flux composition obtained in Example 12 is after being heated on a magnesium-containing aluminum alloy material;

FIG. 3 is a scanning electron photomicrograph (SEM) illustrating how a flux composition obtained in Comparative Example 1 is after being heated on a magnesium-containing aluminum alloy material;

FIG. 4 is a superimposed photograph taken with an electron probe X-ray microanalyzer (EPMA), illustrating how a flux composition obtained in Example 13 is before and after being heated on a magnesium-containing aluminum alloy material; and

FIG. 5 is a superimposed photograph taken with an electron probe X-ray microanalyzer (EPMA), illustrating how a flux composition obtained in Comparative Example 1 is before and after being heated on a magnesium-containing aluminum alloy material.

### DESCRIPTION OF THE PREFERRED EMBODIMENTS

Embodiments of the flux composition and the brazing sheet according to the present invention will be sequentially illustrated in detail below.

### Flux Composition

The flux composition according to the present invention is used for brazing of a magnesium-containing aluminum alloy material. The flux composition includes a flux component [A] containing one or more fluorides as principal components; and an additive [B] being at least one selected from the group consisting of CeF₃, BaF₂, and ZnSO₄. The flux composition, even applied in a small mass of coating (mass of deposit per unit area), provides better wettability and thereby gives better brazability, because the additive [B] suppresses the formation of high-melting compounds. The respective components will be described below.

### Flux Component [A]

The flux component [A] is a known brazing flux component which contains one or more fluorides as principal components and is not limited in its chemical composition. Exemplary fluorides to be contained in the flux component [A] include potassium fluoride (KF) aluminum fluoride (AlF₃); and compounds formed from these compounds, such as KAlF₄ (compound composed of KF and AlF₃) and K₃AlF₆. The flux component [A] melts prior to the components of the filler material during heating (temperature rising) process in brazing, thereby removes an oxide film on the surface of the aluminum alloy material, and covers the surface of the aluminum alloy material to prevent re-oxidation of aluminum.

The flux component [A] preferably includes KF and AlF₃. The flux component [A], when including KF and AlF₃ in a predetermined compounding ratio, helps the flux composition to have a lowered melting point within a preferred range.

When the flux component [A] includes KF and AlF₃, it is more preferred that the content of KF is 40 percent by mass or more and 60 percent by mass or less, and the content of AlF₃ is 40 percent by mass or more and 60 percent by mass or less, each based on the total amount of the flux component [A]. The flux component [A], when having the above-specified chemical composition, efficiently helps the flux composition to have a low melting point within a more preferred range and to thereby have better wettability. If the contents of KF and AlF₃ are out of the range, the flux composition may have a higher melting point and may thereby cause insufficient brazability.

### Additive [B]

The additive [B] is at least one selected from the group consisting of cerium fluoride (CeF₃), barium fluoride (BaF₂), and zinc sulfate (ZnSO₄). These additives [B] suppress the formation of high-melting compounds (e.g., KMgF₃ and MgF₂) which are formed as a result of a reaction of magnesium in the aluminum alloy material with the flux component [A]. The flux composition therefore gives, when used in brazing, a flux on the magnesium-containing aluminum alloy material having better wettability and exhibiting better brazability.

While detailed reasons remain unknown, the additive [B] suppresses the formation of the high-melting compounds and thereby improves the wettability probably for the following reason. Specifically, the additive [B] preferentially reacts with magnesium to form another compound than the high-melting compounds, and, in addition, this reaction suppresses the consumption of the customary flux component (flux component [A]) to thereby improve the wettability.

Though not critical, the upper limit of the content of the additive [B] is preferably 300 parts by mass and more preferably 100 parts by mass, per 100 parts by mass of the flux component [A]. If the content of the additive [B] exceeds the upper limit, the content of the flux component [A] becomes relatively low, and this may cause insufficient wettability (spreadability). For providing both satisfactory brazability and good economical efficiency, the upper limit is more preferably 80 parts by mass when the additive [B] is CeF₃; and is 40 parts by mass when the additive [B] is BaF₂.

Also though not critical, the lower limit of the content of the additive [B] is preferably 1 part by mass and more preferably 10 parts by mass, per 100 parts by mass of the flux component [A]. When two or more compounds are used as the additives [B], the term “content of the additive [B]” refers to a total content of the two or more compounds.

The flux composition may further contain any of other components, in addition to the flux component [A] and the additive [B], within a range not adversely affecting advantageous effects of the present invention.

A method for producing the flux composition is not limited and may typically be a method of blending the flux component [A] and the additive [B] in suitable proportions. Exemplary techniques for the blending include a technique of blending respective components as powders to give a mixture, heating and melting the mixture typically in a crucible, and cooling the molten product to thereby give a solid or powdery flux composition; and a technique of suspending respective components as powders in a suspension medium such as water to give a flux composition as a paste or slurry.

An aluminum alloy material to be brazed with the flux composition is not limited, as long as being a material including a magnesium-containing aluminum alloy, and may be a material composed of such an aluminum alloy alone or a multilayer composite material (e.g., brazing sheet) including a layer composed of an aluminum alloy material; and a layer composed of another material.

The upper limit of the magnesium content in the aluminum alloy material (aluminum alloy) is preferably 1.5 percent by mass, more preferably 1.0 percent by mass, and particularly preferably 0.5 percent by mass. Magnesium, if contained in a content of more than the range, may cause the flux composition to fail to exhibit sufficient brazability. The lower limit of the magnesium content in the aluminum alloy material (aluminum alloy) is not limited and may typically be 0.01 percent by mass.

The flux composition is also usable for brazing of an aluminum alloy material containing no magnesium; and is usable as a flux layer of a brazing sheet using, as a core material, an aluminum alloy containing no magnesium.

### Brazing Sheet

The brazing sheet according to the present invention is a brazing sheet including a core material containing a magnesium-containing aluminum alloy; a filler material being present on or above at least one side of the core material; and a flux layer being present on or above the surface of the filler material and including the flux composition. Examples of the layer structure of the brazing sheet (layer structure including the core material and the filler material) also include structures having three or more layers, such as a three-layered structure with double-coated filler material [(filler material)/(core material)/(filler material)]; and a four-layered structure [e.g., (filler material)/(core material)/(intermediate layer)/(filler material)].

The brazing sheet further includes a flux layer composed of the flux composition on a surface of the filler material and thereby suppresses, upon brazing, the formation of high-melting compounds derived from magnesium in the core material. The brazing sheet therefore exhibits better brazability.

The core material is not limited, as long as being a magnesium-containing aluminum alloy. The magnesium content in the core material preferably falls within the range specified in the aluminum alloy material.

The filler material is not limited and may be any of known ones. Preferred examples of the filler material include those having a melting point higher than that of the flux component [A] by about 10° C. to 100° C., which are typified by Al—Si alloys. Among them, more preferred are Al—Si alloys having a Si content of 5 percent by mass or more and 15 percent by mass or less. These Al—Si alloys (as the filler material) may further contain other components such as Zn and Cu.

The flux layer is a layer made from the flux composition. Though process is not limited, the flux layer may be formed, for example, by a process of suspending the flux composition in a suspension medium such as water to give a suspension as a liquid (may also be a slurry or paste), and applying the suspension to the surface of the filler material.

Though not critical, the lower limit of the amount (mass of coating) of the flux composition in the flux layer is preferably 0.5 g/m², and more preferably 1 g/m². The flux composition, when present in an amount equal to or more than the lower limit, may exhibit sufficient wettability (spreadability). In contrast, the upper limit of the amount of the flux composition is preferably 100 g/m², more preferably 60 g/m², furthermore preferably 20 g/m², and particularly preferably 10 g/m². The flux composition, when applied in an amount equal to or less than the upper limit, may contribute to cost reduction due to reduction in amount of the flux composition while maintaining sufficient wettability (spreadability) necessary for brazing.

The dimensions (sizes) of the core material and other members in the flux composition are not limited and may be known dimensions. A production method of the brazing sheet is also not limited and may be any of known production methods.

The brazing sheet preferably further includes a sacrificial material being arranged on the other side of the core material and having a potential less noble than that of the core material. The brazing sheet, when having such a sacrificial material, may exhibit further better corrosion resistance.

The sacrificial material may be made from any material, as long as having a potential less noble than that of the core material, which is typified by Al—Zn alloys having an Al content of 1 to 5 percent by mass; and Al alloys having a Si content of 0.5 to 1.1 percent by mass, a Mn content of 2.0 percent by mass or less, and a Zn content of 0.6 to 2.0 percent by mass.

### Brazing Method

The flux composition according to the present invention is applicable to a brazing method which is a method for brazing a magnesium-containing aluminum alloy material using a filler material. Brazing, when performed according to the method in combination with the flux composition, exhibits satisfactory brazability even when the flux composition is applied in a small mass of coating (mass of deposit per unit area), and thereby excels in economical efficiency.

Examples of the filler material for use in the brazing method include those exemplified as the filler material to be arranged in the brazing sheet.

A technique for applying (depositing) the flux composition to a brazing region is not limited and is typified by suspending the flux composition in a suspension medium such as water to give a suspension (may be a slurry or paste) and applying the suspension to the brazing region, or dipping the brazing region in the suspension.

The lower limit of the mass of coating (in terms of solids content) of the flux composition to the brazing region is preferably 0.5 g/m², and more preferably 1 g/m². The flux composition, when applied in a mass of coating of equal to or more than the lower limit, can exhibit sufficient wettability (spreadability). In contrast, the upper limit of the mass of coating of the flux composition is preferably 100 g/m², more preferably 60 g/m², furthermore preferably 20 g/m², and particularly preferably 10 g/m². The flux composition, when applied in a mass of coating of equal to or less than the upper limit, may contribute to cost reduction due to reduction in amount of the flux composition while maintaining sufficient wettability (spreadability) necessary for brazing.

After applying the flux composition as the suspension thereto, the brazing region is generally dried. The brazing region is then heated at a temperature lower than the melting point of the aluminum alloy constituting the core material and higher than the melting point of the flux (e.g., at a temperature of 580° C. or higher and 615° C. or lower) to melt the flux and the filler material to thereby perform brazing.

The heating may be performed at a rate of temperature rise of about 10° C. to about 100° C. per minute. Though not critical, the heating time is preferably short, for the reduction of migration of magnesium which adversely affects brazability. The heating time is typically about 5 to about 20 minutes.

The heating may be performed under known atmosphere conditions and is preferably performed in a non-oxidative atmosphere such as an inert gas atmosphere. For the suppression of oxidation, the oxygen concentration during the heating is preferably 1000 ppm or less, and more preferably 400 ppm or less. The atmosphere in the heating preferably has a dew point of −35° C. or lower.

Examples of the brazing method using the flux composition according to the present invention further include a method for carrying out brazing with the brazing sheet. Heating conditions (e.g., temperature, rate of temperature rise, and oxygen concentration) and other conditions in the brazing with the brazing sheet are as with the conditions described in the above-mentioned brazing method.

### Structure

In a structure formed by brazing with the brazing sheet or by the brazing method, the magnesium-containing aluminum alloy material is brazed using the flux composition by once melting and then solidifying, and the brazing region is firmly joined (bonded). The structure can therefore have a high strength and a light weight as a structure using a magnesium-containing aluminum alloy material.

The structure does not always have to be composed of the brazing sheet alone, may include a portion using another material, or may include a portion which has been brazed using another flux composition.

Examples of the structure include automotive heat exchangers such as radiators, evaporators, and condensers. Such heat exchangers, as using the brazing sheet including a magnesium-containing aluminum alloy material (core material), have higher strengths and smaller thicknesses and, as using the flux composition according to the present invention, excel in brazability and are brazed firmly.

### EXAMPLES

The present invention will be illustrated in further detail with reference to several working examples below. It should be noted, however, that these examples are never construed to limit the scope of the present invention.

### Example 1

A flux component [A] was prepared by blending KF and AlF₃ in a molar ratio of 1:1. To 100 parts by mass of the flux component [A], 20 parts by mass of BaF₂ was added as an additive [B], mixed therewith, and yielded a flux composition according to Example 1.

### Examples 2 to 11

Flux compositions according to Examples 2 to 11 were prepared by the procedure of Example 1, except for using an additive [B] of the type in the content (part by mass) given in Table 1.

### Evaluation

In 100 mL of ion-exchanged water was added and suspended 0.04 g of each of the above-prepared flux compositions, and thereby yielded a suspension containing the sample flux composition. The suspension was added dropwise to a central part of an Al—Mg alloy (having a Mg content of 0.6 percent by mass) sheet having a diameter of 20 mm so that the dropped flux composition was 5 mm in diameter, followed by drying. The mass of the alloy sheet was measured before and after the addition (application) of the flux composition, and the amount of the suspension to be dropped was adjusted so as to give a mass of coating (solids content) of the flux composition of 1 to 10 g/m². The alloy sheet on which the flux composition had been deposited was heated at 600° C. in an atmosphere having a dew point of −40° C. and an oxygen concentration of 100 ppm or less for 10 minutes. The heating up to 600° C. was performed at a rate of temperature rise of 50° C. per minute.

Using an electron probe X-ray microanalyzer (EPMA), fluorine element mapping was performed on the surface of each alloy sheet before and after heating, and a spreading rate was calculated according to the following expression as an index for the evaluation of spreadability (wettability) of the flux composition as a result of heating.

$$Spreading rate ( \% ) = 100 \times \frac{Diameter of fluorine \text{-} existing region after heating}{Diameter of fluorine \text{-} existing region before heating} - 100$$

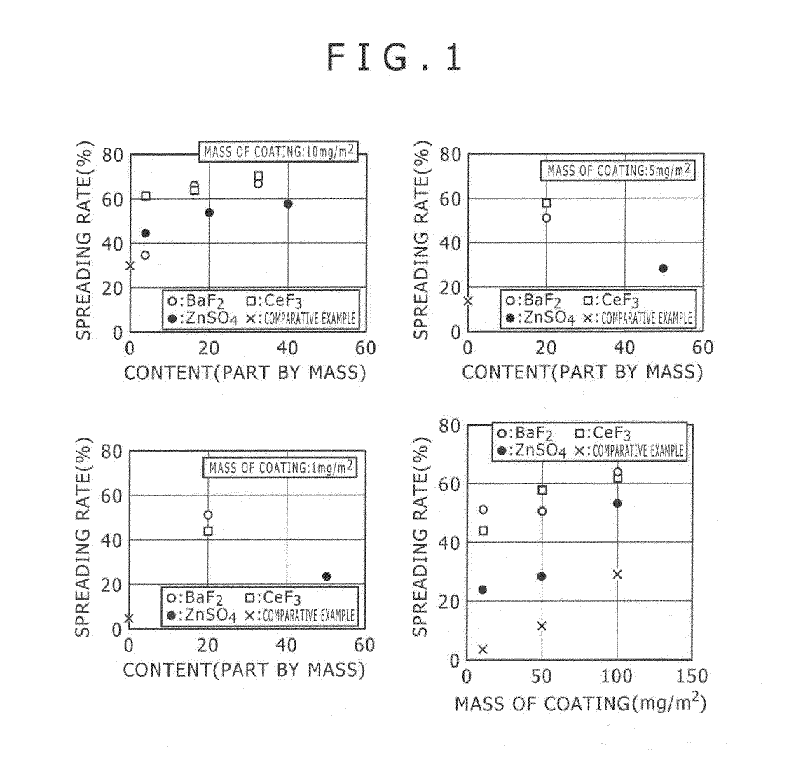

As Comparative Examples 1 to 3, flux compositions each containing a flux component [A] alone but containing no additive [B] were evaluated by the above procedure. The determined spreading rates are indicated in Table 1 and FIG. 1.

TABLE 1

| | Additive [B] | | Mass of | |
|---|---|---|---|---|
| | | Content | coating | Spreading |
| | Type | (part by mass) | (g/m²) | rate (%) |
| Example 1 | BaF₂ | 20 | 10 | 64.4 |
| | | | 5 | 50.9 |
| | | | 1 | 51.1 |
| Example 2 | BaF₂ | 10 | 10 | 34.0 |
| Example 3 | BaF₂ | 40 | 10 | 66.0 |
| Example 4 | BaF₂ | 80 | 10 | 67.0 |
| Example 5 | CeF₃ | 20 | 10 | 62.0 |
| | | | 5 | 58.0 |
| | | | 1 | 44.0 |
| Example 6 | CeF₃ | 10 | 10 | 61.0 |
| Example 7 | CeF₃ | 40 | 10 | 64.0 |
| Example 8 | CeF₃ | 80 | 10 | 71.0 |
| Example 9 | ZnSO₄ | 50 | 5 | 29.0 |
| | | | 1 | 24.0 |
| | | | 10 | 54.0 |
| Example 10 | ZnSO₄ | 10 | 10 | 44.0 |
| Example 11 | ZnSO₄ | 100 | 10 | 58.0 |
| Comparative | — | 0 | 10 | 30.0 |
| Example 1 | | | | |
| Comparative | — | 0 | 5 | 12.0 |
| Example 2 | | | | |
| Comparative | — | 0 | 1 | 4.0 |
| Example 3 | | | | |

The spreading rate increases with an increasing mass of coating (mass of deposit per unit area) of the flux composition, and it is therefore reasonable to admit the effect of the addition of an additive [B] when a sample containing the additive [B] has a spreading rate lager than that of a sample containing no additive [B]. As is demonstrated by Table 1 and FIG. 1, the flux compositions of Examples 1 to 11 according to the present invention have better spreadability when compared with that of the flux compositions according to Comparative Examples 1 to 3 at the same mass of coating.

### Example 12

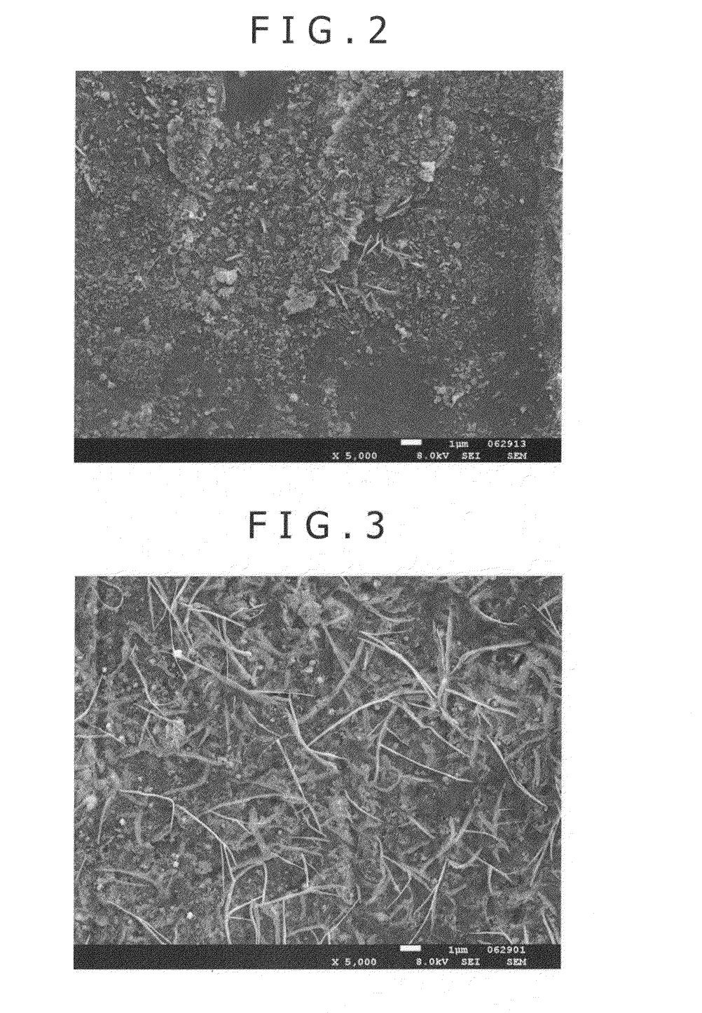

A flux composition according to Example 12 was prepared by the procedure of Example 1, except for using 30 parts by mass of BaF₂ as the additive [B]. Except for using the flux composition prepared in Example 12, an alloy sheet was coated with the flux composition, heated, cooled, and the surface of which was observed with a scanning electron microscope (SEM) by the procedure in the evaluation. The observed image is indicated in FIG. 2. Independently, the observed image of the surface of the alloy sheet after heating using the flux composition according to Comparative Example 1 containing the flux component [A] alone is indicated in FIG. 3.

The photomicrograph of FIG. 2 demonstrates that precipitation of needle-shaped high-melting compounds is hardly observed when the flux composition prepared in Example 12 is used. In contrast, the photomicrograph of FIG. 3 demonstrates that large amounts of needle-like high-melting compounds are precipitated on the surface when the flux composition according to Comparative Example 1 containing the flux component [A] alone is used.

### Example 13

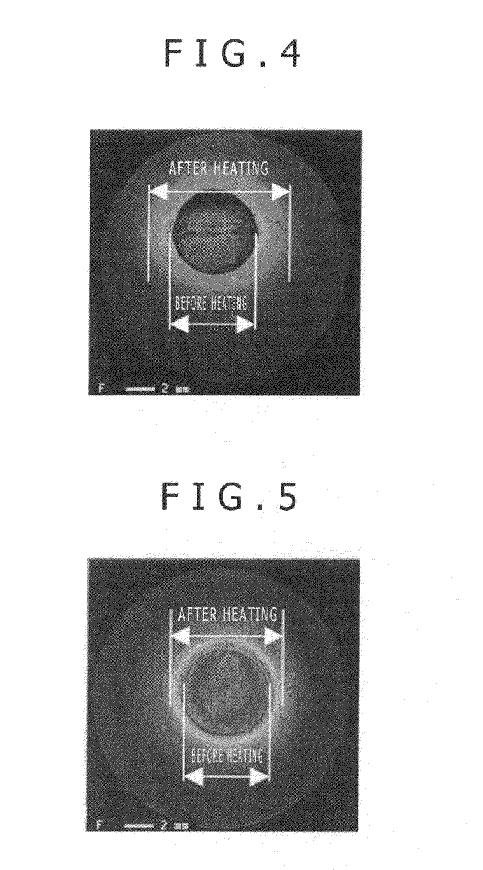

A flux composition according to Example 13 was prepared by the procedure of Example 1, except for using 30 parts by mass of ZnSO₄ as the additive [B]. The flux composition prepared in Example 13 was applied to an alloy sheet and heated by the procedure as in the evaluation. A superimposed photomicrograph taken with an EPMA before and after heating is indicated as FIG. 4. Independently, a superimposed photomicrograph taken with EPMA before and after heating upon the use of the flux composition according to Comparative Example 1 including the flux component [A] alone is indicated in FIG. 5. A comparison between the EPMA photomicrographs of FIG. 4 and FIG. 5 demonstrates that the flux composition according to the present invention sufficiently spreads as a result of heating (has a high spreading rate).

The flux compositions according to the present invention are advantageously usable for brazing of magnesium-containing aluminum alloys. Specifically, they are advantageously usable typically in production of automotive heat exchangers made from aluminum alloys.

1. A flux composition for brazing of a magnesium-containing aluminum alloy material, the flux composition comprising:
a flux component [A] containing one or more fluorides as principal components; and
an additive [B] being at least one selected from the group consisting of CeF₃, BaF₂, and ZnSO₄.

2. The flux composition according to claim 1,
wherein the flux component [A] contains KF and AlF₃, and
wherein the flux component [A] contains KF in a content of 40 percent by mass or more and 60 percent by mass or less; and AlF₃ in a content of 40 percent by mass or more and 60 percent by mass or less, each based on the total mass of the flux component [A].

3. The flux composition according to one of claims 1 and 2, wherein the flux composition contains the additive [B] in a content of 1 part by mass or more and 300 parts by mass or less, per 100 parts by mass of the flux component [A].

4. A brazing sheet comprising:
a core material including a magnesium-containing aluminum alloy;
a filler material being present on or above at least one side of the core material; and
a flux layer being present on or above a surface of the filler material and including the flux composition of one of claims 1 and 2.

5. The brazing sheet according to claim 4, wherein the flux composition in the flux layer is present in an amount of 0.5 g/m² or more and 100 g/m² or less.
